(19) United States
(12) Patent Application Publication
(10) Pub. No.: US 2008/0037451 A1
(43) Pub. Date: Feb. 14, 2008

(54) NEUTRALIZATION OF ACOUSTIC ECHO CANCELLATION IN PRESENCE OF SIGNAL CLIPPING

(75) Inventors: Mikhail U. Yagunov, Pompano Beach, FL (US); Pratik V. Desai, Boca Raton, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/460,790

(22) Filed: Jul. 28, 2006

(51) Int. Cl. H04B 3/20

(52) U.S. Cl. 370/289

(57) ABSTRACT

A method and a system for implementing echo cancellation. The method (300, 400) can include, on a first communication device (200), generating an acoustic signal (130) corresponding to an audio signal (110) received from a second communication device. Responsive to receiving a portion of the acoustic signal and detecting it is clipped, filter coefficient adaptation in an echo cancellation system (205) can be neutralized. For example, filter coefficients can be maintained at previous values, a control signal (230) that indicates zero error can be provided to an adaptive algorithm (235) that generates filter coefficients (225), a control signal can be provided that indicates to the adaptive algorithm to halt automatic updating of the filter coefficients that are generated, or a control signal can be provided that indicates to an adaptive filter (245) to halt automatic updating of the filter coefficients that are processed.

### BACKGROUND OF THE INVENTION

1. Field of the Invention

The present invention generally relates to communication devices and, more particularly, to communication devices that implement or use echo cancellation.

2. Background of the Invention

Modern communication devices, such as mobile telephones, oftentimes include an analog to digital converter (ADC) and a digital to analog converter (DAC) to convert audio signals between analog and digital formats. ADCs, DACs, and associated amplifiers typically have limited dynamic range, however, which sometimes results in clipping of analog audio signals. Unfortunately, such clipping disrupts proper operation of echo cancelling circuits and, rather than cancelling unwanted echo signals, the echo cancelling circuits generate unwanted noise.

FIG. 1 depicts a block diagram of a communication device 100 that is useful for understanding how such disruption occurs. During operation in receive mode, the communication device 100 can receive an audio signal 110 to be presented to a user. The audio signal 110 is typically received from another communication device as a digital signal and processed using components known in the art, such as transceivers, controllers, etc. For the purpose of simplification, we can simply state that the audio signal 110 is received from a far end 105.

In an arrangement in which the audio signal 110 is a digital signal, the audio signal 110 can be communicated to a DAC 115 that converts the audio signal 110 to an analog audio signal, which then may be amplified by an output amplifier 120 and applied to an output audio transducer 125 to generate an acoustic signal 130. Although the acoustic signal 130 is intended to radiate away from the communication device 100, an unintended portion of the acoustic signal 130 oftentimes is received by the communication device's input audio transducer 135 (e.g. a microphone). The received acoustic signal then may be amplified by an input amplifier 140 and applied to an ADC 145 for analog to digital conversion, resulting in an echo 150 of the audio signal 110. Such an echo 150 is especially problematic when the communication device 100 is being operated in speakerphone mode because in that mode the acoustic volume generated by the output audio transducer 125 is rather large in comparison to other modes of operation, and thus the portion of the acoustic signal 130 detected by the microphone 135 can be relatively higher.

To reduce the amount of the echo 150 that is returned to the communication device at the far end 105, an echo cancellation system 155 is typically implemented between the ADC 145 and other processing circuits, such as a noise suppressor 160 and/or vocoder 165. A typical echo cancellation system 155 can include an adaptive algorithm 170 that models the echo path and processes an error signal 175 to generate filter coefficients 180. The filter coefficients 180 can be used by a filter 185 to process the audio signal 110 and generate an echo estimation 190 that closely matches the echo 150. An example of the adaptive algorithm 170 is a normalized least mean square (NLMS) algorithm and an example of the filter 185 is a finite impulse response (FIR) filter, although other algorithms and filters are known in the art. Using an adder 195, the echo estimation 190 can be subtracted from the echo 150.

Unfortunately, when the echo 150 is clipped by the amplifier 140 or ADC 145, the echo estimation 190 does not properly cancel the echo 150. Specifically, because the echo estimation 190 is generated from the audio signal 110, which remains unclipped, the amplitude and spectral content of the echo estimation 190 fail to match the echo 150. In addition to the echo 150 not being cancelled, substantial audio noise may be generated by the unmatched correction signal 190 when clipping of the echo 150 occurs.

### SUMMARY OF THE INVENTION

The present invention relates to a method and a system for implementing echo cancellation. The method can include, on a first communication device, generating an acoustic signal corresponding to an audio signal received from a second communication device. At least a portion of the generated acoustic signal may be received. Responsive to detecting that the received portion of the acoustic signal is clipped, filter coefficient adaptation in an echo cancellation system can be neutralized.

In one arrangement, neutralizing filter coefficient adaptation can include maintaining filter coefficients at previous values. Neutralizing filter coefficient adaptation also can include providing to an adaptive algorithm that generates filter coefficients a control signal that indicates zero error. In another arrangement, neutralizing filter coefficient adaptation can include providing to the adaptive algorithm a control signal that indicates to the adaptive algorithm to halt automatic updating of the filter coefficients that are generated. In yet another arrangement, neutralizing the filter coefficient adaptation also can include providing to an adaptive filter that processes filter coefficients a control signal that indicates to the adaptive filter to halt automatic updating of the filter coefficients that are processed.

The method also can include setting a counter value for a counter in response to detecting that the received portion of the acoustic signal is clipped, and decrementing the counter value in response to detecting a next received portion of the acoustic signal is not clipped. Filter coefficients can be changed in response to the counter value reaching zero. Further, the filter coefficients can be maintained at previous values until the counter value reaches zero.

Detecting that the received portion of the acoustic signal is clipped can include detecting a signal sample for an audio signal that corresponds to the received portion of the acoustic signal and detecting that the signal sample represents at least a threshold amplitude value.

The present invention also relates to an echo cancellation system. The echo cancellation system can include an adaptive filter and an adaptation control module. The adaptation control module can neutralize filter coefficient adaptation in the echo cancellation system in response to detecting that a received portion of an acoustic signal is clipped.

The adaptation control module can neutralize filter coefficient adaptation by maintaining filter coefficients at previous values. In one arrangement, the adaptation control module can provide a control signal that indicates zero error to an adaptive algorithm that generates filter coefficients. In another arrangement, the adaptation control module can provide to the adaptive algorithm a control signal that indicates to the adaptive algorithm to halt automatic updating of the filter coefficients that are generated. In yet another arrangement, the adaptation control module can provide to an adaptive filter that processes filter coefficients a control signal that indicates to the adaptive filter to halt automatic updating of the filter coefficients that are processed.

Responsive to detecting that the received portion of the acoustic signal is clipped, the adaptation control module can set a counter value for a counter. In response to detecting a next received portion of the acoustic signal is not clipped, the adaptation control module can decrement the counter value. The adaptive algorithm can change filter coefficients in response to the counter value reaching zero. Further, the adaptive algorithm can maintain the filter coefficients at previous values until the counter value reaches zero.

The adaptation control module can detect that the received portion of the acoustic signal is clipped by detecting a signal sample for an audio signal that corresponds to the received portion of the acoustic signal, and detecting that the signal sample represents at least a threshold amplitude value.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a block diagram of a communication device that is useful for understanding the present invention;

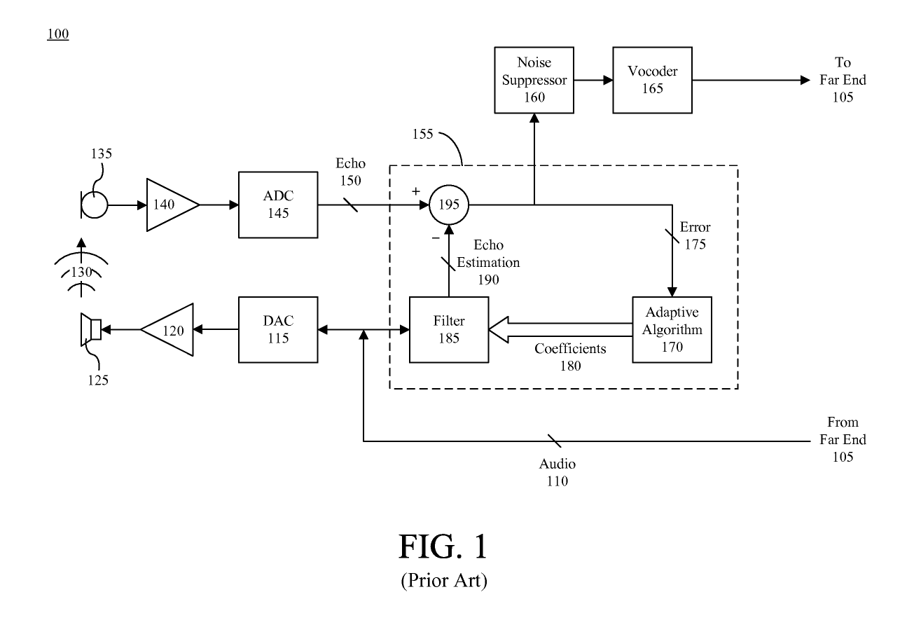

FIG. 2 depicts another block diagram of a communication device that is useful for understanding the present invention;

FIG. 3 is a flowchart that is useful for understanding the present invention; and

FIG. 4 is another flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

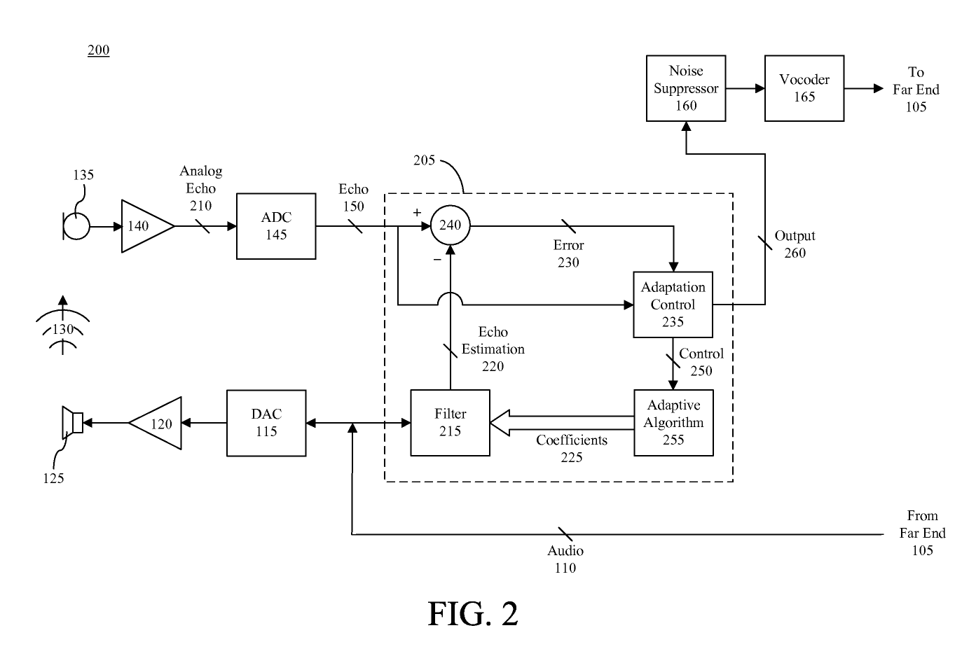

The present invention relates to a method and a system for improving echo cancellation when clipping occurs on an echo. FIG. 2 depicts a block diagram of a communication device 200 that is useful for understanding the invention. The communication device 200 can include an improved echo cancellation system 205. In addition to cancelling an echo 150 while the communication device 200 is operating in receive mode, the echo cancellation system 205 can neutralize filter coefficient adaptation when clipping of the echo 150 is detected, thereby minimizing, or preventing, noise caused by unmatched echo estimation.

As used herein, the term “echo” is a signal corresponding to a portion of an acoustic signal 130 that is received by a communication device from which the acoustic signal originally radiated. In the present arrangement, the echo 150 can be received by the audio input transducer 135 in an analog echo signal 210, and converted into a digital signal by the analog to digital converter (ADC) 145. The ADC 145 can generate the digital form of the echo 150 by sampling the analog echo signal 210 output by the input audio transducer 135 or the amplifier 140.

As used herein, the term “filter coefficient adaptation” is the process of updating filter coefficients 225 for use by a filter 215 to generate an echo estimation 220. To generate the echo estimation 220, the filter 215 can apply the filter coefficients 225 to an algorithm that is used to filter the audio signal 110. The filter 215 can be a finite impulse response (FIR) filter, an infinite impulse response filter (IIR), or any other suitable filter.

In operation, while the echo 150 remains unclipped and the filter coefficients 225 are converged with the echo 150, the filter 215 generates an echo estimation 220 that very closely matches the echo 150. Since an error signal 230 is calculated using an adder 240 to subtract the echo estimation 220 from the echo 150, the error signal 230 generally is small. Because the amount by which the filter coefficients 225 change as they are updated directly correlates to the size of the error signal 230, the filter coefficients 225 do not change greatly as the unclipped echo 150 continues to be received, and thus the filter coefficients 225 remain converged with the echo 150.

When the echo 150 is clipped, the amplitude of the echo 150 remains relatively constant, and is only slightly greater than the amplitude that was measured by the last sample before clipping began. The amplitude of the received audio signal 110, however, may continue to increase. Since the echo estimation 220 is generated by filtering the audio signal 110, it too may continue to increase. Accordingly, the difference between the echo estimation 220 and the echo 150 will increase, thereby generating an error signal 230 that becomes relatively large. Without intervention, the filter coefficients 225 also will increasingly diverge from their optimal value, thereby causing divergence of the echo estimation 220 and the echo 150. In such an arrangement, much of the echo 150 will remain uncorrected and additional noise will be generated whenever clipping of the echo 150 occurs. Thus, if the error signal 230 is provided as an output signal 260 that is communicated to other components of the communication device 200, such as a noise suppressor 160 and/or vocoder 165, much of the echo 150 and noise will be present.

To understand how neutralizing filter coefficient adaptation minimizes the amount of echo 150 and noise being communicated to the other components of the communication device 200 when the echo 150 is clipped, assume that the last digital sample of the echo 150 is measured just before clipping of the analog echo signal 210 begins. Rather than allowing the filter coefficients 225 to increase as the error signal 230 increases, the filter coefficients 225 that are determined using the last sample prior to clipping can continue to be used by the filter 215 to generate an echo estimation 220 that is a very good approximation of the clipped echo 150. Accordingly, the echo estimation 220 and the echo 150 can remain converged, and the error signal 230 may represent only the approximate difference between the clipped echo 150 and the echo 150 were it not to be clipped (i.e. the portion of signal clipped from the echo 150).

Detection of the clipping of the echo 150 can be accomplished in any suitable manner. For example, the echo cancellation system 205 can include an adaptation control module 235. The adaptation control module 235 can comprise hardware, software or firmware executable by a suitable processing device, or a combination of hardware and software. The adaptation control module 235 can be communicatively linked to the ADC 145. Although the communication link can be a direct connection, other components (not shown) may be included along the communication pathway. For example, amplifiers, filters, processors, or any other suitable devices may be included. The adaptation control module 235 can receive the echo 150, or a representation of the echo 150, from the ADC 145.

The adaptation control module 235 can process the echo 150 to determine whether the echo 150 is being clipped. For example, the adaptation controller 235 can be configured to identify whether the echo 150 has an amplitude equal to at least a threshold value. The threshold value may be close to, or equal to, a maximum output amplitude of the amplifier 140 or a maximum amplitude of analog signals within the ADC 145 before analog to digital conversion. To accomplish the identification, the adaptation control module 235 can detect signal samples represented in the echo 150 and identify particular signal samples that represent at least the threshold value.

In response to detecting clipping of the echo 150, filter coefficient adaptation can be neutralized in any suitable manner. For example, the adaptation control module 235 can communicate a control signal 250 to an adaptive algorithm 255. The adaptive algorithm 255 can be a normalized least mean squared (NLMS) algorithm, or any other suitable algorithm that operates in the time domain. During normal operation when the echo 150 is not clipped, the control signal 250 can be equal, or substantially equal, to the error signal 230. When the echo 150 is clipped, however, the adaptation control module 235 can ignore the error signal 230 and provide a control signal 250 that indicates zero error. When the control signal 250 indicates zero error, filter coefficients 225 provided by the adaptive algorithm 255 can be maintained at their previous values before the clipping was detected. In another arrangement, when clipping occurs, the control signal 250 can indicate to the adaptive algorithm 255 to halt automatic updating of the filter coefficients 225 that are generated, and to provide to the filter 215 filter coefficients that were determined immediately prior to the present occurrence of clipping being detected.

In another arrangement, to neutralize filter coefficient adaptation, the adaptation control module 235 can communicate a control signal (not shown) to the filter 215 to halt automatic updating of the filter coefficients 225 that are processed by the filter 215, and to indicate to the filter 215 to process previously provided filter coefficients 225.

In another aspect of the invention, when clipping of the echo 150 is detected, the adaptation control module 235 can set the output signal 260 to a zero value, which can completely eliminate the echo and noise, although audio signals generated by a user of the communication device 200 also would be eliminated when the clipping occurs.

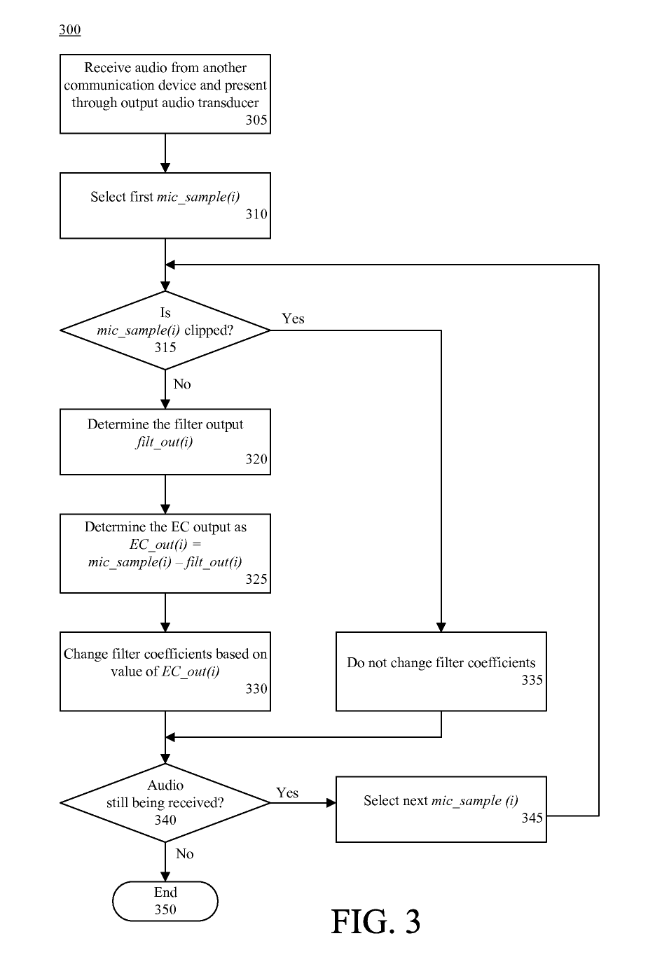

FIG. 3 is a flowchart which presents a method 300 for neutralizing filter coefficient adaptation when signal clipping is detected. The method 300 can be performed, at least in part, by the adaptive control module or any other suitable hardware and/or software components. The method 300 can begin at step 305 in a state in which a first communication device has been receiving audio from another communication device and the first communication device has presented a correlating acoustic signal through an output audio transducer. At least a portion of the acoustic signal may be undesirably received by an input audio transducer and initial filter coefficients may have been generated for echo cancellation. At step 310, a first sample, mic_sample (i), of an audio signal detected by an input audio transducer on the first communication device can be selected. Referring to decision box 315, a determination can be made as to whether the sample is clipped.

If the sample is not clipped, at step 320 an adaptive filter output, filt_out(i), correlating to the sample i can be determined. At step 325, an echo cancellation output, EC_out(i), can be determined for the sample i by subtracting the adaptive filter output from the microphone sample. e.g. EC_out(i)=mic_sample(i)−filt_out(i). Proceeding to step 330, filter coefficients can be changed based on the echo cancellation output, EC_out(i).

Referring again to decision box 315 and step 335, if the first sample mic_sample(i) is clipped, the filter coefficients can remain unchanged and steps 320 through 330 can be skipped. Referring to decision box 340, if audio is still being received from the other communication device, at step 345 a next sample, mic_sample(i), can be selected and the process can return to decision box 315. The process can continue until audio is no longer being received from the other communication device, at which time the process can end at step 350. The process can repeat when audio is again received from another communication device.

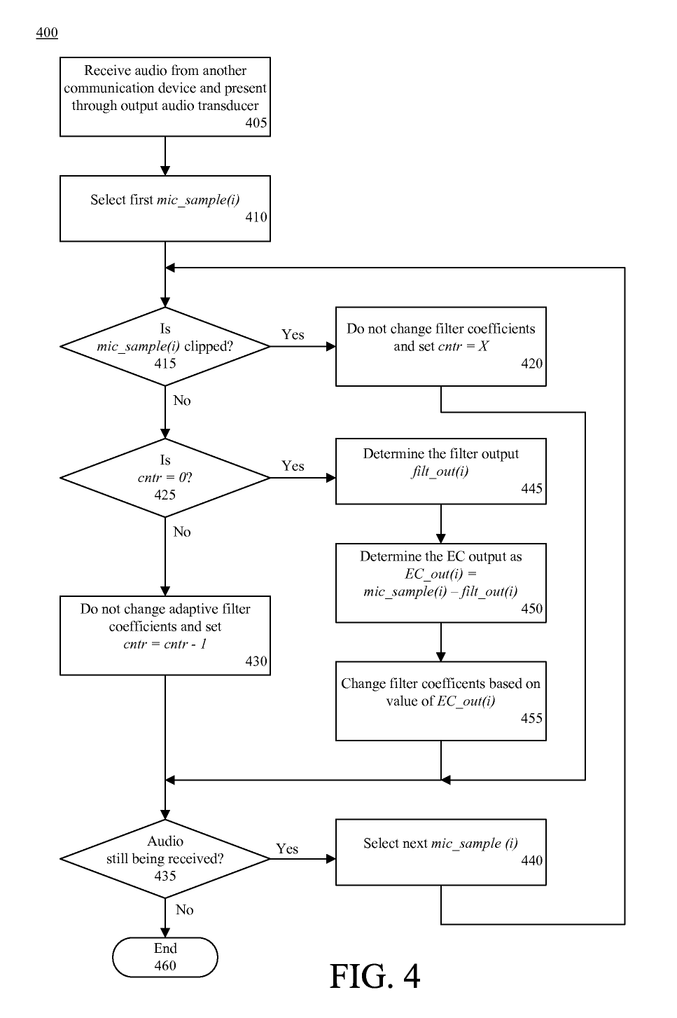

FIG. 4 is another flowchart that is useful for understanding the present invention. The method 400 can be performed, at least in part, by the adaptive control module or any other suitable hardware and/or software components. The method 400 introduces a counter that, after clipping has been detected, maintains filter coefficients unchanged until a plurality of digital audio samples have been measured by the ADC. This arrangement can be implemented if the ADCs require previous audio samples iₙ₋₁, iₙ₋₂, . . . , iₙ₋ₘ to generate a particular sample iₙ. In such an arrangement, if one or more of the previous audio samples iₙ₋₁, iₙ₋₂, . . . , iₙ₋ₘ are clipped, the digital representation of the sample iₙ may be incorrect. Filter coefficients generated from the incorrect digital sample iₙ also may be incorrect, and result in a divergent echo estimation which, as noted, can result in undesirable noise. By maintaining the filter coefficients unchanged until a suitable amount of unclipped audio samples have been measured, noise that otherwise would be generated by use of incorrect filter coefficients can be avoided.

The method 400 can begin at step 405 in a state in which a first communication device has been receiving audio from another communication device and the first communication device has presented a correlating acoustic signal through an output audio transducer. At least a portion of the acoustic signal may be undesirably received by an input audio transducer and initial filter coefficients may have been generated for echo cancellation. At step 410, a first sample, mic_sample(i), of an audio signal detected by an input audio transducer on the first communication device can be selected. Referring to decision box 415, a determination can be made as to whether the sample is clipped.

If the sample is clipped, the process can proceed to step 420 and the filter coefficients can remain unchanged. In addition, a counter, cntr, can be set to a suitable counter value X. The value of X can be selected based on the number of previous audio samples that are used by the ADC to generate a sample(i) with a desired level of accuracy. For example, the value of X can be 5, 10, 50, 100, 500, 1000, 5000, 10000 or any other desired number. Proceeding to decision box 435, if audio is still being received, a next sample mic_sample(i) can be selected at step 440.

Referring again to decision box 415, if the sample mic_sample(i) is not clipped, the process can proceed to decision box 425 and a determination can be made whether cntr is equal to 0. If the cntr is not equal to zero, the process can continue to step 430 can cntr can be decremented by one (i.e. cntr=cntr−1). The process can again proceed to decision box 435 and continue as previously described.

Referring back to decision box 425, if cntr is equal to zero, the process can proceed to step 445 and an adaptive filter output, filt_out(i), correlating to the sample i can be determined. At step 450, an echo cancellation output, EC_out(i), can be determined for the sample i by subtracting the adaptive filter output from the microphone sample. e.g. EC_out(i)=mic_sample(i)−filt_out(i). Proceeding to step 455, filter coefficients can be changed based on the echo cancellation output, EC_out(i). The process can again proceed to decision box 435 and continue until audio is no longer being received, at which time the process can end at step 460. The process can repeat when audio is again received from another communication device.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). This invention can be embodied in other forms without departing from the spirit or essential attributes thereof. Accordingly, reference should be made to the following claims, rather than to the foregoing specification, as indicating the scope of the invention.

What is claimed is:

1. A method for implementing echo cancellation, comprising:
on a first communication device, generating an acoustic signal corresponding to an audio signal received from a second communication device;
receiving at least a portion of the generated acoustic signal; and
responsive to detecting that the received portion of the acoustic signal is clipped, neutralizing filter coefficient adaptation in an echo cancellation system.

2. The method of claim 1, wherein neutralizing filter coefficient adaptation comprises maintaining filter coefficients at previous values.

3. The method of claim 1, wherein neutralizing filter coefficient adaptation comprises providing to an adaptive algorithm that generates filter coefficients a control signal that indicates zero error.

4. The method of claim 1, wherein neutralizing filter coefficient adaptation comprises providing to an adaptive algorithm that generates filter coefficients a control signal that indicates to the adaptive algorithm to halt automatic updating of the filter coefficients that are generated.

5. The method of claim 1, wherein neutralizing filter coefficient adaptation comprises providing to an adaptive filter that processes filter coefficients a control signal that indicates to the adaptive filter to halt automatic updating of the filter coefficients that are processed.

6. The method of claim 1, further comprising:
responsive to detecting that the received portion of the acoustic signal is clipped, setting a counter value for a counter;
responsive to detecting a next received portion of the acoustic signal is not clipped, decrementing the counter value; and
changing filter coefficients in response to the counter value reaching zero.

7. The method of claim 6, further comprising maintaining the filter coefficients at previous values until the counter value reaches zero.

8. The method of claim 1, wherein detecting that the received portion of the acoustic signal is clipped comprises:
detecting a signal sample for an audio signal that corresponds to the received portion of the acoustic signal; and
detecting that the signal sample represents at least a threshold amplitude value.

9. An echo cancellation system, comprising:
an adaptive filter; and
an adaptation control module that, responsive to detecting that a received portion of an acoustic signal is clipped, neutralizes filter coefficient adaptation in the echo cancellation system.

10. The echo cancellation system of claim 9, wherein the adaptation control module neutralizes filter coefficient adaptation by maintaining filter coefficients at previous values.

11. The echo cancellation system of claim 9, wherein in order to neutralize the filter coefficient adaptation the adaptation control module provides to an adaptive algorithm that generates filter coefficients a control signal that indicates zero error.

12. The echo cancellation system of claim 9, wherein in order to neutralize the filter coefficient adaptation the adaptation control module provides to an adaptive algorithm that generates filter coefficients a control signal that indicates to the adaptive algorithm to halt automatic updating of the filter coefficients that are generated.

13. The echo cancellation system of claim 9, wherein in order to neutralize the filter coefficient adaptation the adaptation control module provides to an adaptive filter that processes filter coefficients a control signal that indicates to the adaptive filter to halt automatic updating of the filter coefficients that are processed.

14. The echo cancellation system of claim 9, wherein:
responsive to detecting that the received portion of the acoustic signal is clipped, the adaptation control module sets a counter value for a counter;
responsive to detecting a next received portion of the acoustic signal is not clipped, the adaptation control module decrements the counter value; and
the adaptive algorithm changes filter coefficients in response to the counter value reaching zero.

15. The echo cancellation system of claim 14, wherein the adaptive algorithm maintains the filter coefficients at previous values until the counter value reaches zero.

16. The echo cancellation system of claim 9, wherein the adaptation control module detects that the received portion of the acoustic signal is clipped by detecting a series of signal samples for an audio signal that corresponds to the received portion of the acoustic signal, and determining that each of the series of signal samples represents a respective amplitude, and that the respective amplitudes are approximately equal.

17. A machine readable storage, having stored thereon a computer program having a plurality of code sections comprising:
code for, on a first communication device, generating an acoustic signal corresponding to an audio signal received from a second communication device;
code for receiving at least a portion of the generated acoustic signal; and
code for neutralizing filter coefficient adaptation in an echo cancellation system in response to detecting that the received portion of the acoustic signal is clipped.

18. The machine readable storage of claim 17, wherein the code for neutralizing filter coefficient adaptation comprises code for maintaining filter coefficients at previous values.

19. The machine readable storage of claim 17, wherein the code neutralizing filter coefficient adaptation comprises code for providing to an adaptive algorithm that generates filter coefficients a control signal that indicates to the adaptive algorithm to halt automatic updating of the filter coefficients that are generated.

20. The machine readable storage of claim 17, further comprising:
code for setting a counter value for a counter in response to detecting that the received portion of the acoustic signal is clipped;
code for decrementing the counter value in response to detecting a next received portion of the acoustic signal is not clipped; and
code for changing filter coefficients in response to the counter value reaching zero.
